(19) United States
(12) Patent Application Publication
(10) Pub. No.: US 2025/0034431 A1
(43) Pub. Date: Jan. 30, 2025

(54) METHOD FOR PREPARING CERIUM OXIDE NANOCOMPOSITE, CERIUM OXIDE NANOCOMPOSITE, AND CHEMICAL MECHANICAL POLISHING SOLUTION

(71) Applicant: ANJI MICROELECTRONICS (SHANGHAI) CO., LTD., Shanghai (CN)

(72) Inventors: Xingping WANG, Shanghai (CN); XU Pengyu, Shanghai (CN); CHEN Yinbin, Shanghai (CN); LI Shoutian, Shanghai (CN)

(21) Appl. No.: 18/713,814

(22) PCT Filed: Nov. 30, 2022
(86) PCT No.: PCT/CN2022/135396

§ 371 Date: May 28, 2024

(30) Foreign Application Priority Data
Nov. 30, 2021 (CN) 202111466639.5

(51) Int. Cl. C09G 1/02; C09K 3/14

(52) U.S. Cl. CPC C09G 1/02; C09K 3/1436

(57) ABSTRACT

The present disclosure provides a method for preparing cerium oxide nanocomposites, comprising, a first step: contacting an anionic surface modifier with a water dispersion of cerium oxide nanoparticles to obtain cerium oxide nanocomposites with negatively charged surfaces, wherein the anionic surface modifier is selected from inorganic polyacids and derivatives thereof, and anionic organic polymers; Second step: contacting a cationic surface modifier with the negatively charged cerium oxide nanocomposites obtained in the first step to obtain cerium oxide nanocomposites with positively charged surfaces, wherein the cationic surface modifier is selected from inorganic Lewis acids and derivatives thereof, and cationic organic polymers. The present disclosure achieves the modulation of the chemical mechanical polishing performance of nanoscale cerium oxide through surface modification, addressing the issue of low polishing rate and inefficient planarization associated with negatively charged cerium oxide particles on silicon oxide.

### TECHNICAL FIELD

This present disclosure relates to a method for preparing cerium oxide nanocomposites and the cerium oxide nanocomposites obtained thereby, as well as a chemical polishing solution comprising the cerium oxide nanocomposites.

### BACKGROUND

With the continuous high density and miniaturization of semiconductor components, Chemical Mechanical Planarization (CMP) process plays an indispensable role in the manufacturing process of semiconductor components. In the CMP process, the requirements for chemical mechanical polishing speed, flatness of the polished surface, scratches and defects are increasing. CMP polishing solution has a particularly significant impact on these polishing properties, and polishing particles are the core components of the polishing solution. Cerium oxide primary particles prepared by calcination method and sol-gel method have different surface electrochemical potential values at different pH values. By adding surface modifiers, the surface electrochemical potential of cerium oxide particles can be changed, thereby changing its chemical mechanical polishing performance. Generally, negative charge cerium oxide particles have insufficient polishing speed for silicon oxide and low planarization efficiency. It is necessary to further improve the polishing speed of cerium oxide polishing solution.

### SUMMARY

In response to the low polishing speed and low planarization efficiency of cerium oxide particles with negative charges when used with silicon dioxide, the present disclosure adjusts the chemical mechanical polishing performance of nanoscale cerium oxide through surface modification.

The present disclosure provides a method for preparing cerium oxide nanocomposites, comprising:
Step 1: Contacting an anionic surface modifier with a water dispersion of nanoscale cerium oxide particles to produce cerium oxide nanocomposites with negatively charged surfaces, wherein the anionic surface modifier is selected from inorganic polyacids and derivatives thereof, and anionic organic polymers:
Step 2: Contacting a cationic surface modifier with the negatively charged cerium oxide nanocomposites obtained in the first step to produce cerium oxide nanocomposites with positively charged surfaces, wherein the cationic surface modifier is selected from inorganic Lewis acids and derivatives thereof, and cationic organic polymers.

Preferably, the cerium oxide nanoparticles are selected from cerium oxide particles prepared using the sol-gel method and cerium oxide particles prepared using the calcination method.

Preferably, the inorganic polybasic acid and its derivatives are selected from phosphoric acid and phosphoric acid derivatives, silicic acid and silicic acid derivatives, and paraperiodic acid and paraperiodic acid derivatives.

Preferably, the phosphoric acid and its derivatives are selected from phosphoric acid, pyrophosphoric acid, pyrophosphite acid, tripolyphosphoric acid, potassium hydrogen phosphate, dipotassium hydrogen phosphate, potassium dihydrogen phosphate, potassium phosphate, ammonium phosphate, calcium phosphate, metaphosphoric acid, and ATMP (nitrilotrimethylphosphonic acid).

Preferably, the anionic organic polymer is carboxylic compounds and their derivatives.

Preferably, the anionic surface modifier has a mass percentage content ratio to the cerium oxide nanoparticles of 0.001-1.

Preferably, the inorganic Lewis acid is selected from aluminum sulfate, aluminum chloride, aluminum nitrate, zinc chloride, and ferric bromide.

Preferably, the cationic organic polymer is a quaternary ammonium cationic polymer.

Preferably, the cationic organic polymer is selected from a dimethyl diallyl ammonium chloride homopolymer, a dimethyldiallylammonium chloride and acrylamide copolymer, a dimethyldiallylammonium chloride and acrylic acid copolymer, a 2-Methacryloxyethyl trimethyl ammonium chloride and acrylamide copolymer.

Preferably, the mass percentage ratio of cationic surface modifier to cerium oxide nanoparticles is 0.001-1.

Preferably, the mass percentage content ratio of the cationic surface modifier to the cerium oxide nanoparticles is 0.2-0.5.

Another aspect of the present disclosure provides an oxidized cerium nanocomposite obtained by any of the methods described above.

In another aspect of the present disclosure, a chemical mechanical polishing solution comprising the cerium oxide nanocomposite as described above is provided.

The method provided by the present disclosure can effectively improve the surface properties of cerium oxide particles, thereby further increasing the polishing rate and planarization efficiency of cerium oxide polishing solution.

### DETAILED DESCRIPTION

The advantages of the present disclosure will be explained in detail with reference to the following embodiments.

### Comparative Embodiment 1A

Add 1.4 g of phosphoric acid to 420 g of deionized water, adjust the pH to 10 by adding potassium hydroxide, stir for 5 minutes, then add 85.0 g of 30% concentration cerium oxide sol (particle size 160 nm). Stir for 30 minutes, then transfer to an ultrasonic bath operating at 20 kHz for 60 minutes for ultrasonic dispersion. Finally, a cerium oxide composite dispersion with a concentration of 5 wt % is obtained. The pH, particle size, and zeta potential of the cerium oxide composite are listed in Table 1.

### Comparative Embodiment 1B

Add 80 grams of cerium oxide composite from Example 1A to 1920 grams of deionized water, stir well, and obtain a cerium oxide polishing solution with a cerium oxide content of 0.2 wt %.

### Comparative Embodiment 2A

Add 3.5 g of 10 wt % polyaspartic acid (molecular weight ˜5000) water solution into 329.8 g of deionized water, stir for 5 minutes, then add 166.7 g of 30 wt % cerium oxide (light scattering particle size 160 nm), stir for 30 minutes, and transfer to a 20 kHz ultrasonic bath for sonication for 60 minutes. Finally, obtain cerium oxide composite with a concentration of 10 wt % and polyaspartic acid concentration of 0.07 wt % (polyaspartic acid-cerium oxide nanocomposite). The pH, particle size, and zeta potential of the cerium oxide composite are listed in Table 1.

### Comparative Embodiment 2B

Add 40 grams of cerium oxide composite from Example 2A into 1960 grams of deionized water, stir evenly, and obtain cerium oxide polishing solution with a cerium oxide content of 0.2 wt %.

### Comparative Embodiment 3A

Add 1.6 g of 5 wt % poly(acrylate ammounium) (molecular weight ˜5000) water solution to 598.4 g of deionized water, stir for 5 minutes, then add 400 g of 5 wt % cerium oxide (with a light scattering particle size of 160 nm), stir for 30 minutes, and transfer to an ultrasonic bath at 20 kHz for 60 minutes. Finally, a cerium oxide composite (polyaspartic acid-cerium oxide nanocomposite) with a cerium oxide concentration of 2 wt % and a poly(acrylate ammounium) concentration of 0.04 wt % is obtained. The pH, particle size, and zeta potential of the cerium oxide composite are listed in Table 1.

### Comparative Embodiment 3B

Add 200 grams of cerium oxide composite from Example 3A to 1800 grams of deionized water, stir evenly, and obtain a cerium oxide polishing solution with a cerium oxide content of 0.2 wt %.

### Comparative Embodiment 4A

Add 1.53 grams of ATMP to 423.47 grams of deionized water, stir for 5 minutes, then add 85 grams of 30 wt % cerium oxide (with a particle size of 160 nm), and stir for 30 minutes. Transfer to a 20 kHz ultrasonic bath and disperse with ultrasound for 60 minutes. In the end, a negative charged cerium oxide composite (phosphate-cerium oxide nanocomposite) with a cerium oxide concentration of 5 wt % and a phosphate concentration of 0.125 wt % was obtained. The pH, particle size, and zeta potential of the cerium oxide composite are listed in Table 1.

### Comparative Embodiment 4B

Add 80 grams of cerium oxide composite from Example 4A to 1920 grams of deionized water, stir evenly, and obtain a cerium oxide polishing solution with a cerium oxide content of 0.2 wt %.

### Embodiment 1A: Preparation of Cerium Oxide Nanocomposites

### Step 1: Preparation of Negative Charge Cerium Oxide Nanocomposites

The procedure of Comparative Embodiment 1A was repeated to obtain a negative charged cerium oxide composite dispersion solution having a cerium oxide concentration of 5 wt %.

### Step 2: Preparation of Positive Charge Cerium Oxide Nanocomposites

12.5 g of 2 wt % polyquaternium-7 was added to 787.5 g of deionized water, stirred for 5 min, added 200 g of the negative charge cerium oxide nanocomposites prepared in Example 1-1A, stirred for 30 min, transferred to an ultrasonic tank at 20 kHz, and ultrasonic dispersed for 60 min. Finally, a second cerium oxide composite (polyquaternium-7-phosphate-cerium oxide nanocomposite) with a cerium oxide concentration of 1 wt % was obtained. The pH, particle size and zeta potential of the cerium oxide composite are listed in Table 1.

### Embodiment 1B: Preparation of Polishing Solution Containing Cerium Oxide Nanocomposite

Add 400 grams of the cerium oxide composite prepared in Example 1A to 1600 grams of deionized water, stir evenly, and obtain a cerium oxide polishing solution with a cerium oxide content of 0.2 wt %.

### Embodiment 2A: Preparation of Cerium Oxide Nanocomposite

### Step 1: Preparation of Negatively Charged Cerium Oxide Nanocomposite

Repeat the steps of Comparative Embodiment 2A to obtain a cerium oxide composite with a concentration of 10 wt % cerium oxide and 0.07 wt % polyaspartic acid (polyaspartic acid-cerium oxide nanocomposite).

### Step 2: Preparation of Positively Charged Cerium Oxide Nanocomposite

62.5 g of 1 wt % polyquaternium-7 was added to 187.5 g of deionized water, stirred for 5 min, and 250 g of cerium oxide composite prepared in the first step was added, stirred for 30 min, transferred to an ultrasonic tank at 20 kHz, and ultrasonic dispersed for 60 min. Finally, a cerium oxide composite (polyquaternium-7-polyaspartic acid-cerium oxide) with a cerium oxide concentration of 5 wt % was obtained. The pH, particle size, and zeta potential of the cerium oxide composite are listed in Table 1.”

### Embodiment 2B: Preparation of Polishing Solution Containing Cerium Oxide Nanocomposite

Add 160 grams of the cerium oxide composite from Example 2A into 1840 grams of deionized water, stir evenly, to obtain a cerium oxide polishing solution with a cerium oxide content of 0.2 wt %.

### Embodiment 3A: Preparation of Cerium Oxide Nanocomposite

### Step 1: Preparation of Negatively Charged Cerium Oxide Nanocomposite

Repeating the steps of Comparative Embodiment 3A, obtain a cerium oxide composite (poly(acrylate ammounium)-cerium oxide nanocomposite) with a cerium oxide concentration of 2 wt % and a poly(acrylate ammounium) concentration of 0.04 wt %.

### Step 2: Preparation of Positively Charged Cerium Oxide Nanocomposite

Add 12.5 grams of 2 wt % aluminum nitrate to 787.5 grams of deionized water, stir for 5 minutes, then add 200 grams of the cerium oxide composite prepared in the first step, stir for 30 minutes, transfer to an ultrasonic bath operating at 20 kHz, and Ultrasonic dispersion for 60 minutes. Finally, obtain a cerium oxide composite (aluminum nitrate-poly(acrylate ammounium)-cerium oxide nanocomposite) with a cerium oxide concentration of 1 wt %. The pH, particle size, and zeta potential of the cerium oxide composite are listed in Table 1.

### Embodiment 3B: Preparation of Polishing Solution Containing Cerium Oxide Nanocomposite

Add 400 grams of the cerium oxide composite from Embodiment 3A into 1600 grams of deionized water, stir evenly, and obtain a cerium oxide polishing solution with a cerium oxide content of 0.2 wt %.

### Embodiment 4A: Preparation of Cerium Oxide Nanocomposite

### Step 1: Preparation of Negatively Charged Cerium Oxide Nanocomposite

Repeat the steps of Comparative Embodiment 4A to obtain a negatively charged cerium oxide composite (phosphate-cerium oxide nanocomposite) with a cerium oxide concentration of 5 wt % and a phosphate concentration of 0.125 wt %.

### Step 2: Preparation of Positively Charged Cerium Oxide Nanocomposite

Add 12.5 grams of 2 wt % aluminum nitrate to 787.5 grams of deionized water, stir for 5 minutes, then add 200 grams of the cerium oxide composite prepared in the first step, and stir for 30 minutes. Transfer the mixture to an ultrasonic bath operating at 20 kHz and sonicate for 60 minutes. Finally, a second cerium oxide composite (aluminum nitrate-phosphate-cerium oxide nanocomposite) with a cerium oxide concentration of 1 wt % was obtained. The pH, particle size, and zeta potential of the cerium oxide composite are listed in Table 1.

### Embodiment 4B: Preparation of Polishing Solution Containing Cerium Oxide Nanocomposite

Add 400 grams of the cerium oxide composite from Embodiment 4A to 1600 grams of deionized water, stir evenly, and obtain a cerium oxide polishing solution with a cerium oxide content of 0.2 wt %.

TABLE 1
Comparative Embodiment and Embodiment Measurements
of Surface Potential, Particle Size, and
Stability of Cerium Oxide Composite

| | | Surface Potential | Particle Size | stability of |
|---|---|---|---|---|
| Example | pH | (mV) | (nm) | colloid |
| Comparative | 10.8 | −45 | 160 | >3 weeks |
| Embodiment1A | | | | |
| Embodiment1A | 4.5 | 12 | 250 | >3 weeks |
| Comparative | 10.5 | −30 | 160 | >3 weeks |
| Embodiment2A | | | | |
| Embodiment2A | 4.6 | 32 | 270 | >3 weeks |
| Comparative | 8.4 | −41 | 160 | >3 weeks |
| Embodiment | | | | |
| 3A | | | | |
| Embodiment3A | 3.8 | 30 | 172 | >3 weeks |
| Comparative | 11.0 | −46 | 160 | >3 weeks |
| Embodiment4A | | | | |
| Embodiment4A | 3.8 | 31 | 179 | >3 weeks |

Based on the test results in Table 1, it can be concluded that the preparation method of the organic-inorganic nanocomposite provided in this application can achieve stable dispersion of cerium oxide particles and can also alter the surface charge properties of the cerium oxide composite. Specifically, treating cerium oxide with anionic surfactants can result in cerium oxide nanocomposites with a surface carrying negative charge. Furthermore, further treatment of the negatively charged cerium oxide nanocomposites with cationic surfactants can result in cerium oxide nanocomposites with a positive charge. After surface modification, there is a significant increase in the particle size of the cerium oxide particles.

To further illustrate the advantages of the organic-inorganic nanocomposite prepared in the present disclosure, the polishing rate of the organic-inorganic nanocomposite on silica was further tested in the above-mentioned embodiments. The specific test conditions are as follows:

Use CMP grinding equipment (manufactured by Applied Materials, commercial name: Mirra) for polishing. The polishing pad used is the IC1000 polishing pad manufactured by 3M company, with a grinding pressure of 2.0 psi, and the rotation speeds of the grinding disk and the platen are 93 rpm and 87 rpm, respectively. The polishing solution flow rate is 150 mL/min.

A 200 mm PE-TEOS silicon oxide film is used as the semiconductor substrate, and the NanoSpec film thickness measurement system (NanoSpec6100-300, Shanghai NanoSpec Technology Corporation) is used to measure the TEOS film thickness variation. Starting from 3 mm from the wafer edge, 49 points are measured at equal intervals along the diameter line. The polishing rate is the average of the 49 points. The test results are shown in Table 2.

TABLE 2
Polishing Rate of cerium oxide polishing solution

| | grinding | | | | | TEOS |
|---|---|---|---|---|---|---|
| | particle | anionic additive | | cationic additive | | RR |
| | content | Substance | Concentration | Substance | Concentration | (Å/min) |
| Embodiment 1B | 0.2 | phosphoric acid | 0.005 | Polyquaternium-7 | 0.01 | 3019 |
| Comparative | 0.4 | phosphoric acid | 0.01 | — | — | 889 |
| Embodiment1B | | | | | | |
| Embodiment 2B | 0.2 | polyaspartic | 0.014 | Polyquaternium-7 | 0.005 | 2628 |
| | | acid | | | | |
| Comparative | 0.4 | polyaspartic | 0.028 | — | — | 760 |
| Embodiment2B | | acid | | | | |
| Embodiment 3B | 0.2 | poly(acrylate | 0.008 | aluminum | 0.0012 | 2322 |
| | | ammounium) | | nitrate | | |
| Comparative | 0.2 | poly(acrylate | 0.008 | — | — | 1667 |
| Embodiment 3B | | ammounium) | | | | |
| Embodiment 4B | 0.2 | amino | 0.0012 | aluminum | 0.0024 | 2419 |
| | | tri(methylene | | nitrate | | |
| | | phosphonic | | | | |
| | | acid) | | | | |
| Comparative | 0.2 | amino | 0.0012 | — | — | 1933 |
| Embodiment 4B | | tri(methylene | | | | |
| | | phosphonic | | | | |
| | | acid) | | | | |

As shown in Table 2, the polishing particles used in the comparative embodiment polishing solution are all cerium oxide nanocomposites with negative charges; the polishing particles used in the embodiment polishing solution are all cerium oxide nanocomposites with positive charges. Compared with the same group of the comparative embodiment and the embodiment polishing solution, the silica polishing speed of the embodiment polishing solution is higher than that of the comparative embodiment. The results show that the cerium oxide nanocomposites with positive charges have higher silica polishing speed than the cerium oxide nanocomposites with negative charges. However, in the actual use process, other types of additives may be added according to the actual needs, and the properties of the cerium oxide particles surface have different requirements. The preparation method of the present disclosure can be used to modify the surface of cerium oxide accordingly to meet actual requirements.

It should be noted that the embodiments of the present disclosure are preferable embodiments and do not impose any form of limitation on the present disclosure. Any person skilled in the art may utilize the disclosed technical content to change or modify it into equivalent effective embodiments. Any modification or equivalent changes and modifications made to the above embodiments based on the technical essence of the present disclosure, which does not depart from the scope of the technical solution of the present disclosure, are still within the scope of the technical solution of the present disclosure.

1. A method for preparing cerium oxide nanocomposites, comprising:
Step 1: Contacting an aqueous dispersion of cerium oxide nanoparticles with an anionic surface modifier to obtain cerium oxide nanocomposites with a negatively-charged surface, wherein the anionic surface modifier is selected from inorganic polybasic acids and their derivatives, and anionic organic macromolecules;
Step 2: Contacting a cationic surface modifier with the negatively charged cerium oxide nanocomposites obtained in Step 1 to obtain cerium oxide nanocomposites with a positively-charged surface, wherein the cationic surface modifier is selected from inorganic Lewis acids and their derivatives, and cationic organic macromolecules.

2. A method according to claim 1, characterized in that, the cerium oxide nanoparticles are selected from cerium oxide particles obtained by sol-gel method and cerium oxide particles obtained by calcination method.

3. A method according to claim 1, characterized in that, the inorganic polybasic acids and their derivatives include phosphoric acid and its derivatives, silicic acid and its derivatives, and paraperiodic acid and paraperiodic acid derivatives.

4. A method according to claim 3, characterized in that, the phosphoric acid and its derivatives are selected from phosphoric acid, pyrophosphoric acid, pyrophosphite acid, tripolyphosphoric acid, potassium hydrogen phosphate, dipotassium hydrogen phosphate, potassium dihydrogen phosphate, potassium phosphate, ammonium phosphate, calcium phosphate, metaphosphoric acid, and ATMP (nitrilotrimethylphosphonic acid).

5. A method according to claim 1, characterized in that, the anionic organic polymer is carboxylic compounds and their derivatives.

6. A method according to claim 1, characterized in that, a mass percentage ratio of the anionic surface modifier to cerium oxide nanoparticles is 0.001-1.

7. A method according to claim 1, characterized in that, the inorganic Lewis is selected from aluminum sulfate, aluminum chloride, aluminum nitrate, zinc chloride, and iron bromide.

8. A method according to claim 1, characterized in that, the cationic organic polymer is a quaternary ammonium cationic polymer.

9. A method according to claim 8, characterized in that, the cationic organic polymer is selected from a dimethyl diallyl ammonium chloride homopolymer, a dimethyldiallylammonium chloride and acrylamide copolymer, a dimethyldiallylammonium chloride and acrylic acid copolymer, a 2-methacryloxyethyl trimethyl ammonium chloride and acrylamide copolymer.

10. A method according to claim 1, characterized in that, a ratio of the mass percentage content of the cationic surface modifier to cerium oxide nanoparticles is 0.001-1.

11. A method according to claim 10, characterized in that, a ratio of the mass percentage content of the cationic surface modifier to cerium oxide nanoparticles is 0.2-0.5.

12. A cerium oxide nanocomposite obtained by the method according to claim 1.

13. A chemical mechanical polishing solution comprising the cerium oxide nanocomposite as claimed in claim 12.
